(19) United States
(12) Patent Application Publication
(10) Pub. No.: US 2025/0258307 A1
(43) Pub. Date: Aug. 14, 2025

(54) EXTRUDED PLASTIC SCINTILLATORS

(71) Applicant: FERMI FORWARD DISCOVERY GROUP, LLC, Chicago, IL (US)

(72) Inventor: Alan Bross, Downers Grove, IL (US)

(21) Appl. No.: 19/052,638

(22) Filed: Feb. 13, 2025

Related U.S. Application Data
(60) Provisional application No. 63/553,426, filed on Feb. 14, 2024.

(51) Int. Cl. G01T 1/203; C08L 25/04; C08L 69/00; C09D 7/61; C09K 11/02

(52) U.S. Cl. CPC G01T 1/2033; C08L 25/04; C08L 69/00; C09D 7/61; C09K 11/02

(57) ABSTRACT

Embodiments are directed to scintillators and methods of forming the same, the methods comprising mixing a polycarbonate with at least one dopant; forming the scintillator from the mixed polycarbonate and at least one dopant and applying a cladding to the scintillator.

### CROSS REFERENCE TO RELATED PATENT APPLICATIONS

This application claims the priority and benefit under 35 U.S.C. § 119(e) of U.S. Provisional Patent Application Ser. No. 63/553,426 filed Feb. 14, 2024, entitled “EXTRUDED PLASTIC SCINTILLATORS.” U.S. Provisional Patent Application Ser. No. 63/553,426 is herein incorporated by reference in its entirety.

### STATEMENT OF GOVERNMENT RIGHTS

The invention described in this patent application was made with Government support under the Fermi Research Alliance, LLC, Contract Number DE-AC02-07CH11359 awarded by the U.S. Department of Energy. The Government has certain rights in the invention.

### TECHNICAL FIELD

The embodiments are generally related to the field of scintillators. Embodiments further relate to the field of plastic scintillators. Embodiments further relate to the field of extruded scintillators. Embodiments further relate to the field of coatings for extruded plastic scintillators. Embodiments are further related to methods and associated systems for manufacturing coated scintillators. Embodiments are further related to cladding materials and processes for forming extruded plastic scintillators with reflective cladding.

### BACKGROUND

Scintillators are a class of materials that exhibit fluorescence when exposed to ionizing radiation. When the scintillator is exposed to an energetic incoming particle, the material absorbs the energy and then emits it, in the form of light.

Scintillation is a well-known property of various materials, and is put to use in a number of fields. For example, scintillators are used with various detector devices like photomultiplier tubes, photodiodes, and other such detectors. Scintillators are used in X-ray security devices, nuclear cameras, medical scanning technologies, and radiation detectors.

One noteworthy class of scintillators are plastic scintillators. Plastic scintillation detectors are used in nuclear and high energy physics. Among their benefits are fast response, ease of manufacture, and versatility.

Polystyrene based scintillators are one known class of scintillator material used in certain high energy physics applications. However, over time the light yield of such scintillators decreases. This degradation is a known problem with this type of plastic scintillator.

In addition to ageing with time and/or radiation, plastic scintillators are very expensive. Significant research has concentrated on improving the fundamental properties of plastic scintillators, but little attention has been paid to their cost. As a result, most currently available plastic scintillators are high quality products with a relatively high cost, and because of that, their use in very large detectors is not a feasible option. For example, a major detector application requiring nominally 400,000 Kg of plastic scintillator with a nominal price of $40 per Kg (a reasonable estimate at current market rates) would be $16,000,000 in material costs alone. Such a detector would likely be cost prohibitive in many circumstances.

As such, there is a need in the art for improved methods and systems for coated plastic scintillators, as disclosed herein.

### SUMMARY

The following summary is provided to facilitate an understanding of some of the innovative features unique to the embodiments disclosed. It is not intended to be a full description. A full appreciation of the various aspects of the embodiments can be gained by taking the entire specification, claims, drawings, and abstract as a whole.

It is, therefore, one aspect of the disclosed embodiments to provide for improved scintillator systems.

It is another aspect of the disclosed embodiments to provide improved methods for scintillation.

It is another aspect of the disclosed embodiments to provide for improved plastic scintillators.

It is another aspect of the disclosed embodiments to provide extruded plastic scintillators.

Another aspect of the disclosed embodiments is directed to methods and associated systems for manufacturing coated scintillators.

It is another aspect of the disclosed embodiments to provide improved and cost effective cladding materials and processes for forming extruded plastic scintillators.

The aforementioned aspects and other objectives and advantages can now be achieved as described herein. In an embodiment, a scintillator, comprises a polycarbonate material, at least one dopant, and a cladding. In an embodiment, the polycarbonate material comprises polycarbonate resin pellets mixed with the at least one dopant. In an embodiment, the cladding comprises a reflective cladding. In an embodiment, the cladding comprises Boron Nitride. In an embodiment, the cladding comprises Barium Sulfate.

In an embodiment, a method for fabricating a scintillator comprises mixing a polymer (e.g. polycarbonate, polystyrene, or the like) with at least one dopant, and forming the scintillator from the mixed polycarbonate and at least one dopant. In an embodiment, mixing a polycarbonate with at least one dopant further comprises mechanically mixing the polycarbonate with the at least one dopant. In an embodiment, mechanically mixing the polycarbonate with the at least one dopant further comprises mixing the polycarbonate and the at least one dopant with a twin-screw extruder. In an embodiment, forming the scintillator further comprises casting the scintillator. In an embodiment, forming the scintillator further comprises injection molding the scintillator. In an embodiment, forming the scintillator further comprises extruding the scintillator. In an embodiment the method comprises applying a cladding to the scintillator. In an embodiment the method comprises painting the cladding on the scintillator. In an embodiment, the cladding comprises at least one of Boron Nitride and Barium Sulfate.

In another embodiment, a method for fabricating a scintillator comprises mixing a polymer with at least one dopant, forming the scintillator from the mixed polycarbonate and at least one dopant, and applying a cladding to the scintillator. In an embodiment, mixing a polycarbonate with at least one dopant further comprises mixing the polycarbonate and the at least one dopant with a twin-screw extruder. In an embodiment, forming the scintillator further comprises casting the scintillator, injection molding the scintillator, or extruding the scintillator. In an embodiment, applying the cladding to the scintillator comprises painting the cladding on the scintillator. In an embodiment, the cladding comprises at least one of Boron Nitride and Barium Sulfate. In an embodiment, applying the cladding to the scintillator further comprises mixing the cladding with the polycarbonate and at least one dopant.

### BRIEF DESCRIPTION OF THE FIGURES

The accompanying figures, in which like reference numerals refer to identical or functionally similar elements throughout the separate views and which are incorporated in and form a part of the specification, further illustrate the embodiments and, together with the detailed description, serve to explain the embodiments disclosed herein.

FIG. 1 illustrates a chemical formula for polycarbonate, in accordance with the disclosed embodiments;

FIG. 2A illustrates a polycarbonate scintillator, in accordance with the disclosed embodiments;

FIG. 2B illustrates a polycarbonate scintillator, in accordance with the disclosed embodiments;

FIG. 3A illustrates a method of fabricating a polycarbonate scintillator, in accordance with the disclosed embodiments;

FIG. 3B illustrates another method of fabricating a polycarbonate scintillator, in accordance with the disclosed embodiments;

FIG. 3C illustrates another method of fabricating a polycarbonate scintillator, in accordance with the disclosed embodiments;

FIG. 4 illustrates an alternative method of fabricating a polycarbonate scintillator, in accordance with the disclosed embodiments;

FIG. 5A illustrates a polystyrene scintillator with a cladding, in accordance with the disclosed embodiments;

FIG. 5B illustrates a polycarbonate scintillator with a cladding, in accordance with the disclosed embodiments;

FIG. 6A illustrates a chart illustrating reflectivity with a BaS0₄ cladding, in accordance with the disclosed embodiments;

FIG. 6B illustrates a chart illustrating reflectivity with a boron nitride cladding, in accordance with the disclosed embodiments;

FIG. 7 illustrates a method of fabricating a cladded scintillator, in accordance with the disclosed embodiments;

FIG. 8A illustrates a method of fabricating a cladded polycarbonate scintillator, in accordance with the disclosed embodiments;

FIG. 8B illustrates another method of fabricating a cladded polycarbonate scintillator, in accordance with the disclosed embodiments; and

FIG. 9 illustrates another method of fabricating a cladded a scintillator, in accordance with the disclosed embodiments.

### DETAILED DESCRIPTION

The particular values and configurations discussed in the following non-limiting examples can be varied, and are cited merely to illustrate one or more embodiments, and are not intended to limit the scope thereof.

Example embodiments will now be described more fully hereinafter with reference to the accompanying drawings, in which illustrative embodiments are shown. The embodiments disclosed herein can be embodied in many different forms and should not be construed as limited to the embodiments set forth herein. Rather, these embodiments are provided so that this disclosure will be thorough and complete, and will fully convey the scope of the embodiments to those skilled in the art. Like reference numerals refer to like elements throughout.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprises” and/or “comprising,” a used in this specification, specify the presence of stated features, integers, steps, operations, elements, and/or components, but do not preclude the presence or addition of one or more other features, integers, steps, operations, elements, components, and/or groups thereof.

Throughout the specification and claims, terms may have nuanced meanings suggested or implied in context beyond an explicitly stated meaning. Likewise, the phrase “in one embodiment” as used herein does not necessarily refer to the same embodiment and the phrase “In another embodiment” as used herein does not necessarily refer to a different embodiment. It is intended, for example, that claimed subject matter include combinations of example embodiments in whole or in part.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations. The principal features can be employed in various embodiments without departing from the scope disclosed herein. Those skilled in the art will recognize, or be able to ascertain, using no more than routine experimentation, numerous equivalents to the specific procedures described herein. Such equivalents are considered to be within the scope of the disclosed embodiments and are covered by the claims.

The use of the word “a” or “an” when used in conjunction with the term “comprising in the claims and/or the specification may mean “one,” but it is also consistent with the meaning of “one or more,” at “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of “having,” such as “have” and “has”), “including” (and any form of “including,” such as “includes” and “include”) or “containing” (and any form of “containing,” such as “contains” and “contain”) are inclusive or open-ended and do not exclude additional, un-recited elements or method steps.

All of the compositions and/or methods disclosed and claimed herein can be made and executed without undue experimentation in light of the present disclosure. While the compositions and methods have been described in terms of preferred embodiments, it will be apparent to those of skill in the art that variations may be applied to the compositions and/or methods and in the steps, or in the sequence of steps, of the method described herein without departing from the concept, spirit, and scope of the disclosed embodiments. All such similar substitutes and modifications apparent to those skilled in the art are deemed to be within the spirit, scope and concept as defined by the appended claims.

The embodiments disclosed herein are directed to improved plastic scintillators, including scintillator materials, coatings for scintillators, and methods for making coated plastic/polymer scintillators.

In an exemplary embodiment, the disclosed embodiments are directed to scintillators using polycarbonate (PC) resin which has excellent light yield. The optical and mechanical properties of PC outperform, or are commensurate with, that of existing scintillators. PC-based scintillators are also more efficient for neutron detectors.

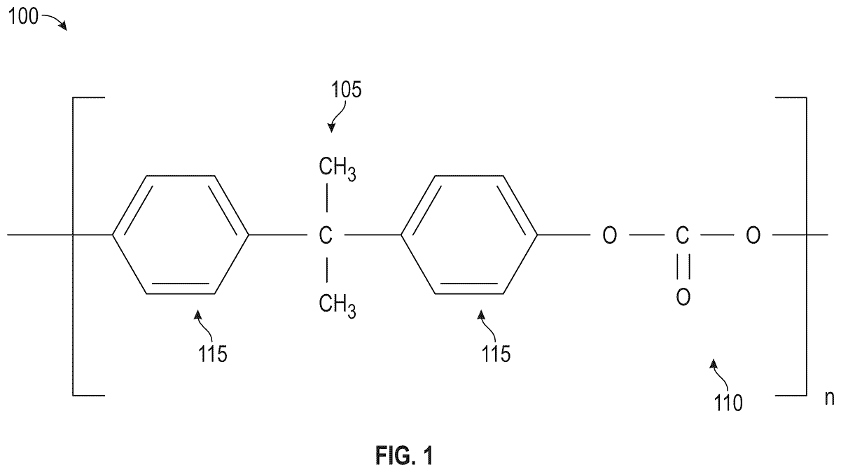

FIG. 1A illustrates the chemical formula 100 for polycarbonate, in accordance with the disclosed embodiments. The polycarbonate molecule 100 is composed of a bisphenol A part 105 and a carbonate group 110. Bisphenol A part 105 can include aromatic benzene rings 115. As illustrated molecule 100 contains two such aromatic rings 115. In other embodiments further detailed herein, the scintillator can be formed of other materials containing a benzene ring 115, including but not limited to, polystyrene (PS), polyvinyltoluene (PVT), or polyethylene naphthalate (PEN).

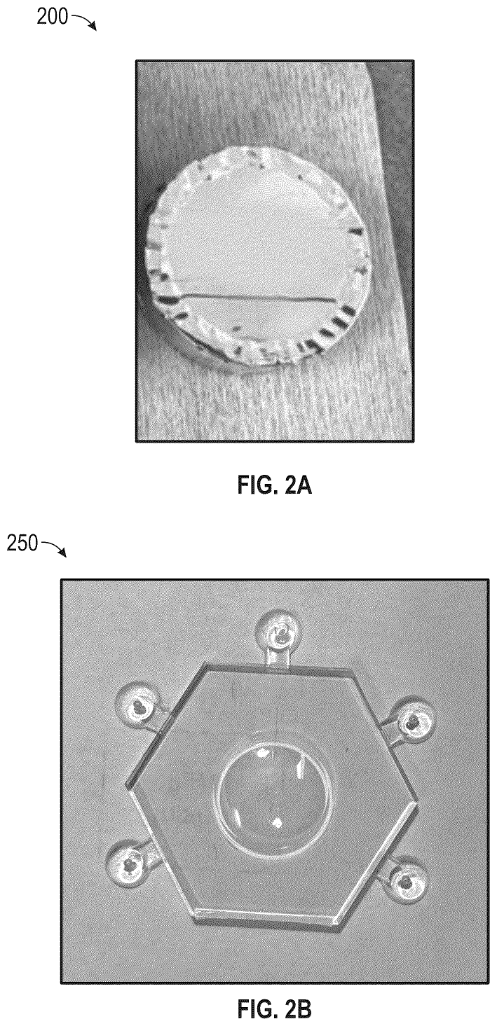

FIG. 2A illustrates a cast polycarbonate scintillator 200 in accordance with the disclosed embodiments. The cast polycarbonate scintillator 200 can be formed of polycarbonate as illustrated in chemical formula 100. The cast polycarbonate scintillator 200 has excellent optical characteristics, mechanical characteristics, robustness to abrasion, radiation resistance, and resistance to adverse environmental conditions (heat in particular). The polycarbonate scintillator 200 also offers excellent light yield.

In certain embodiments, the cast polycarbonate scintillator 200 can be manufactured via casting by first adding a primary dopant to polycarbonate resin pellets. The primary dopant can be p-Terphenyl (pT) or 2,5-Diphenyloxazole (PPO) in a concentration between 1% and 5% by weight.

The manufacturing process can optionally include adding, a secondary wavelength-shifting dopant such as, but not limited to 1,4-Bis(2-methylstyryl)benzene (bis-MSB) or 1,4-bis-2-(5-Phenyloxazolyl)-benzene (POPOP) in a concentration between 0.01% and 0.1%. It should be appreciated that, in other embodiments, the primary dopant can be other materials. The pellets are vigorously mixed and then placed in a vacuum oven for casting.

FIG. 2B illustrates an injection molded polycarbonate scintillator 250 in accordance with the disclosed embodiments. The injection molded polycarbonate scintillator 250 can be formed of polycarbonate as illustrated in chemical formula 100. The injection molded polycarbonate scintillator 250 has excellent optical characteristics, mechanical characteristics, robustness to abrasion, radiation resistance, and resistance to adverse environmental conditions (heat in particular). The polycarbonate scintillator also offers excellent light yield. In certain embodiments, the injection molded polycarbonate scintillator 250 can be manufactured via injection molding.

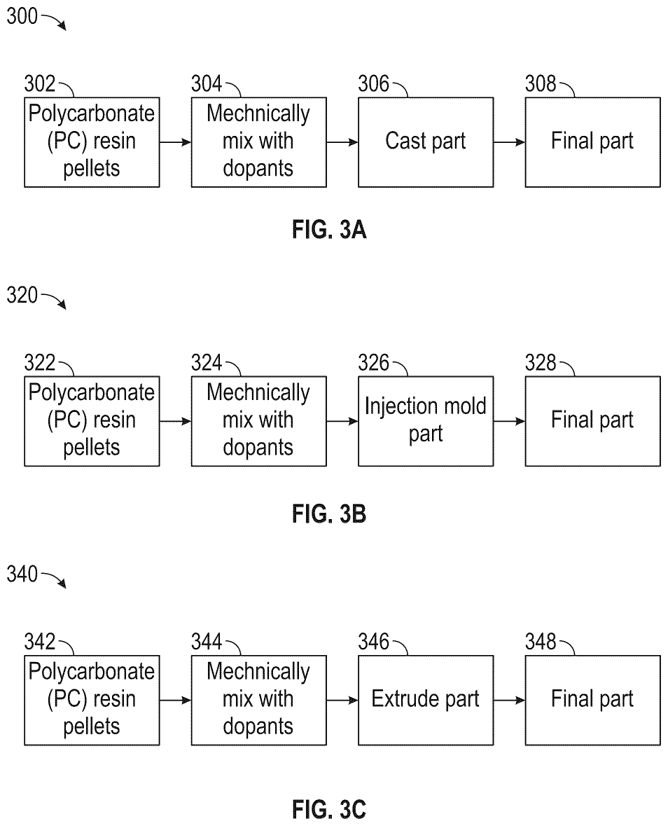

FIG. 3A illustrates an exemplary method 300 of manufacturing a polycarbonate scintillator in accordance with the disclosed embodiments. At step 302 polycarbonate resin pellets can be used. At step 304 the PC resin pellets can be mechanically mixed with a dopant. At step 306, the mixed polycarbonate and dopant can be cast into a scintillator, forming as cast scintillator 200 as illustrated at step 308.

FIG. 3B illustrates another exemplary method 320 of manufacturing a polycarbonate scintillator in accordance with the disclosed embodiments. At step 322 polycarbonate resin pellets can be used. At step 324 the PC resin pellets can be mechanically mixed with a dopant. At step 326, the mixed polycarbonate and dopant can be injection molded into a scintillator, such as injection molded scintillator 250, as illustrated at step 328.

FIG. 3C illustrates another exemplary method 340 of manufacturing a polycarbonate scintillator in accordance with the disclosed embodiments. At step 342 polycarbonate resin pellets can be used. At step 344 the PC resin pellets can be mechanically mixed with a dopant. At step 346, the mixed polycarbonate and dopant can be extruded into a scintillator as illustrated at step 348.

It should be appreciated that, in certain embodiments, the dopants can comprise organic compounds, which are mixed with the pellets by a twin screw extruder which heats the mixture. The dopants can be metered into the twin screw extruder with, for example, a gravimetric feeder.

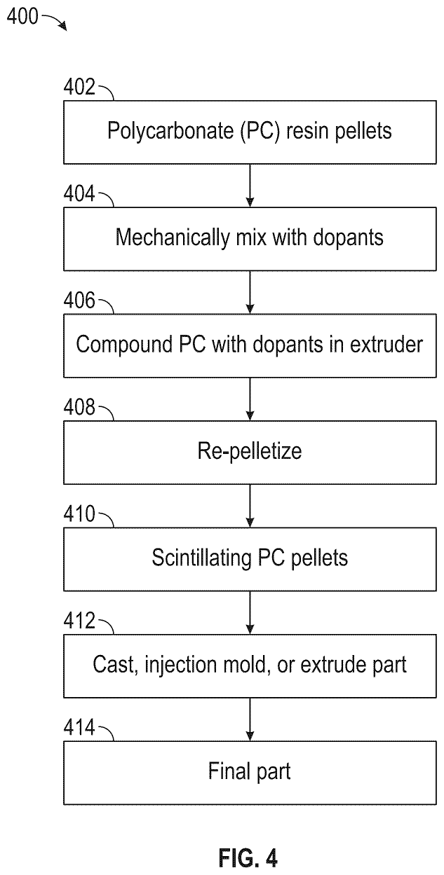

FIG. 4 illustrates another exemplary method 400 of manufacturing a polycarbonate scintillator in accordance with the disclosed embodiments. At step 402 polycarbonate resin pellets can be used. At step 404 the PC resin pellets can be mechanically mixed with a dopant. At step 406, the polycarbonate can be compounded with dopants in an extruder. The mix is then re-pelletized at step 408, in order to form scintillating PC pellets at step 410. Once the pellets are reformed, they can be cast, injection molded, or extruded at step 412 into a final part, as illustrated at step 414.

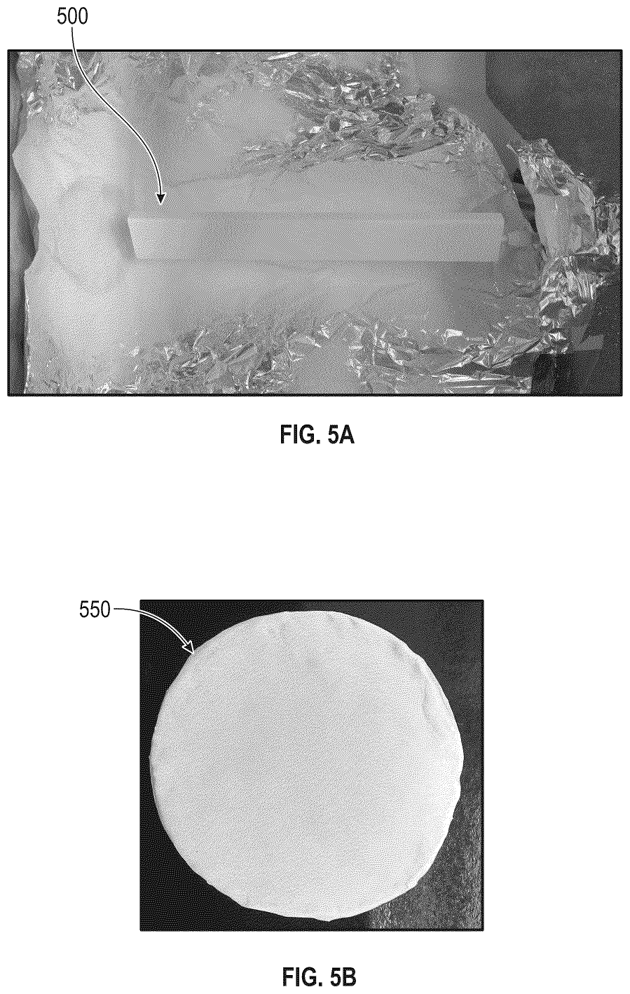

Another aspect of the disclosed embodiments is to apply a reflective cladding or coating to a scintillator, such as a polycarbonate or polystyrene scintillator. FIG. 5A illustrates a BaSO₄ coated polystyrene scintillator extrusion 500, in accordance with the disclosed embodiments. In other embodiments, the scintillator can comprise a polycarbonate. FIG. 5B illustrates a polycarbonate scintillator coated with a Barium sulfate cladding 550, in accordance with the disclosed embodiments.

Barium sulfate (BaSO₄) can be used in combination with the underlying polycarbonate or polystyrene scintillator. In certain embodiments, Barium sulfate and boron nitride (BN) paints can be used as the coating or cladding, as they provide very high efficiency reflection.

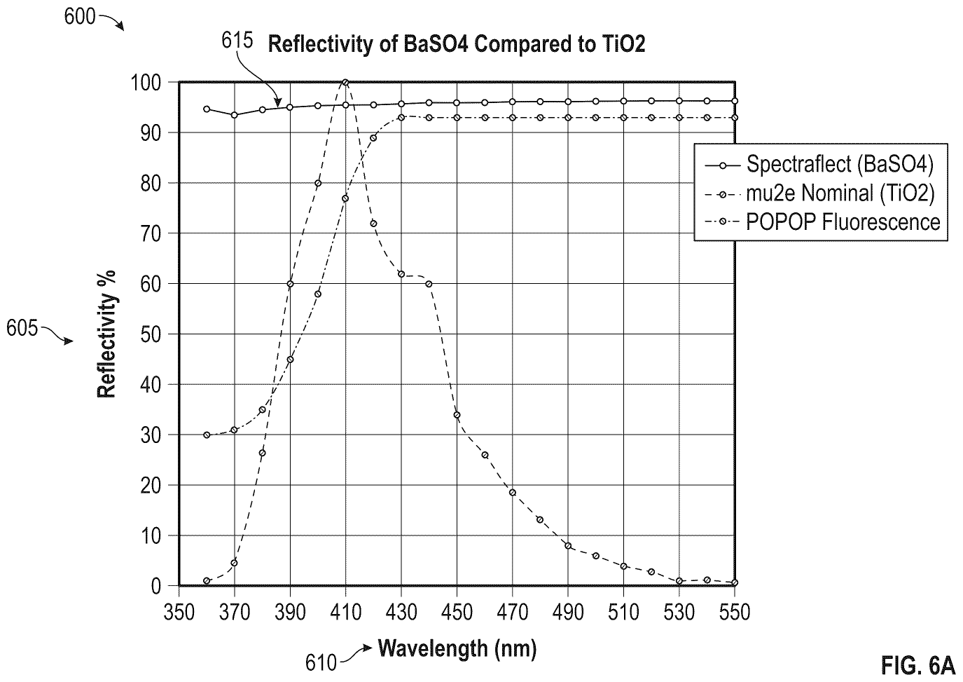

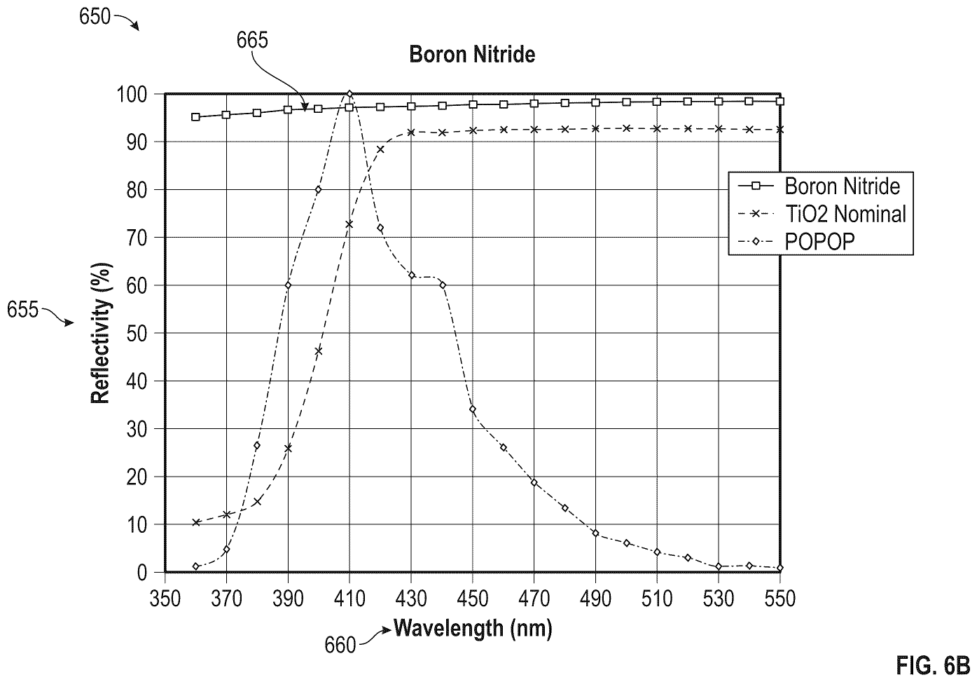

FIG. 6A illustrates a chart 600 illustrating reflectivity 605 as a function of wavelength 610 for various materials. As trace 615 shows, BaSO₄ paint offers excellent reflectivity of a range of wavelengths. Given that the mean number of reflections before a photon is absorbed can be as high as 10, the improvements shown by trace 615 indicates the disclosed BaSO₄ reflector can have an enormous impact on light yield.

FIG. 6B illustrates a chart 650 illustrating reflectivity 655 as a function of wavelength 660 for various materials. As trace 665 shows, boron nitride paint also offers excellent reflectivity of a range of wavelengths. Improvements shown by trace 665 indicate the disclosed boron nitride cladding can significantly impact light yield.

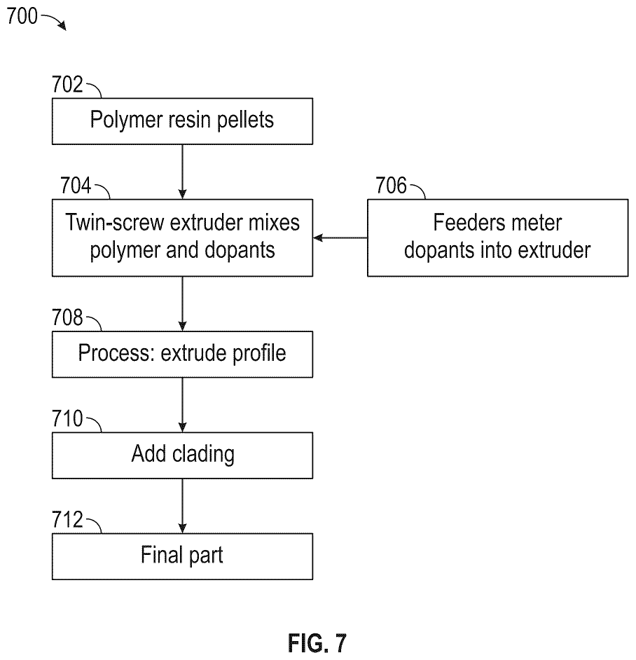

FIG. 7 illustrates steps associated with a method 700 for manufacturing a polymer scintillator with a cladding as disclosed herein. The method starts at 702 with polymer resin pellets. In certain embodiments, the polymer can comprise polycarbonate, polystyrene, or other materials containing a benzene ring.

At step 704 the polymer and dopants can be mixed. In certain embodiments, a twin-screw extruder can be used to mix the polymer and dopants. As illustrated, feeders 706 (e.g. gravimetric feeders) can be used to meter dopants into the extruder, to ensure the proper mixture of polymer and dopants is achieved.

Next, at step 708 extrusion is completed to form the polymer scintillator. Cladding can be added at step 710. In certain embodiments, the cladding can be a reflective cladding or coating such as, barium sulfate or boron nitride (BN) paints. The part is completed at step 712.

In certain alternative embodiments, a buffer layer between the scintillator and cladding can be applied. This can comprise an acrylic based coating. The coating is selected to provide as much internal reflection as possible. This can create an optical wave guide, and also serves to ensure the paint adheres to the scintillator. While barium sulfate and boron nitride are exemplary cladding materials, in other embodiments other cladding materials can be used. These include, but are not limited to, polytetrafluoroethylene (PTFE), magnesium oxide, and titanium oxide (TiO₂).

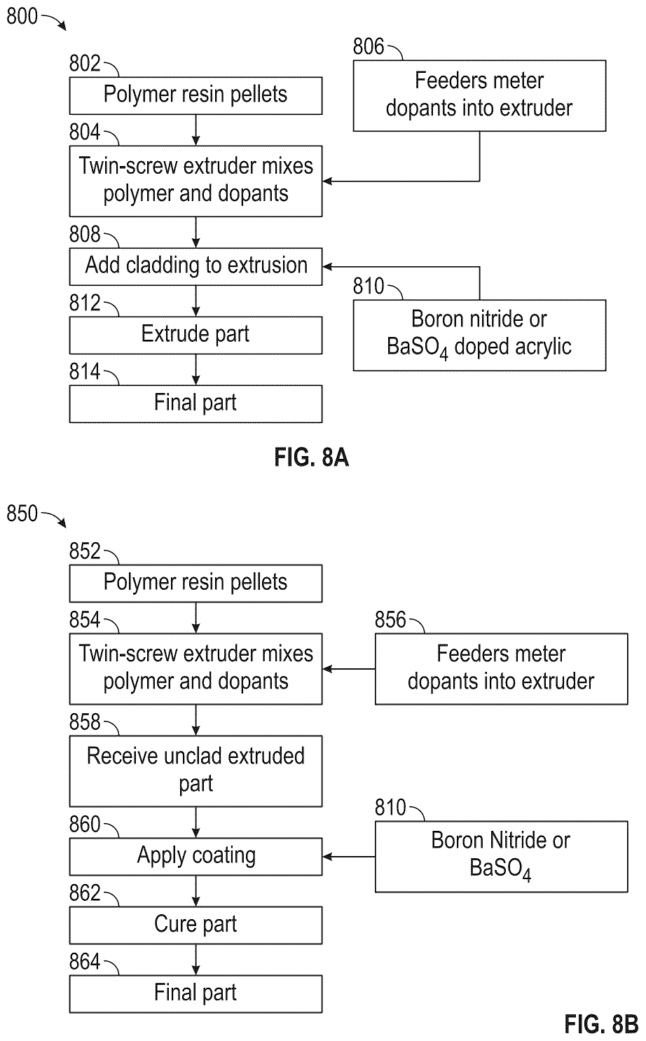

FIG. 8A illustrates an exemplary embodiment of a method 800 for manufacturing a scintillator via coextrusion, in accordance with the disclosed embodiment. The method starts at 802 with polymer resin pellets. As above, in certain embodiments, the polymer can comprise polycarbonate, polystyrene, or other materials containing a benzene ring.

At step 804 the polymer and dopants can be mixed. In certain embodiments, a twin-screw extruder can be used to mix the polymer and dopants. As illustrated, feeders 806 can be used to meter dopants into the extruder, to ensure the proper mixture of polymer and dopants is achieved.

Next, at step 808 cladding can be added to the extrusion. In certain embodiments, the cladding can comprise Boron Nitride or BaSO₄ compounded into a polymer which could be polycarbonate, polystyrene or acrylic 180. In other embodiments polytetrafluoroethylene (PTFE), magnesium oxide, and titanium oxide (TiO₂) or mixtures thereof can be used. Next at step 812, the mixed cladding and doped polymer can be extruded into a part, such as a scintillator. At this point the part is completed at step 814.

FIG. 8B illustrates an exemplary embodiment of a method 850 for manufacturing a scintillator without coextrusion, in accordance with the disclosed embodiment. The method starts at 852 with polymer resin pellets. In certain embodiments, the polymer can comprise polycarbonate, polystyrene, or other materials containing a benzene ring.

At step 854 the polymer and dopants can be mixed. In certain embodiments, a twin-screw extruder can be used to mix the PC and dopants. As illustrated, feeders 856 can be used to meter dopants into the extruder, to ensure the proper mixture of polymer and dopants is achieved.

Next, at step 858 the unclad part can be extruded into a scintillator. Next at step 860 a reflective coating or cladding can be applied. In some embodiments, this can be via painting, but other application methods are also possible. The coating or cladding can comprise Boron Nitride, or BaSO₄.

Once the coating has been applied, at step 862 the coating can be cured. In certain embodiments, this can comprise heat curing and/or UV light curing. At this point the part is completed at step 864.

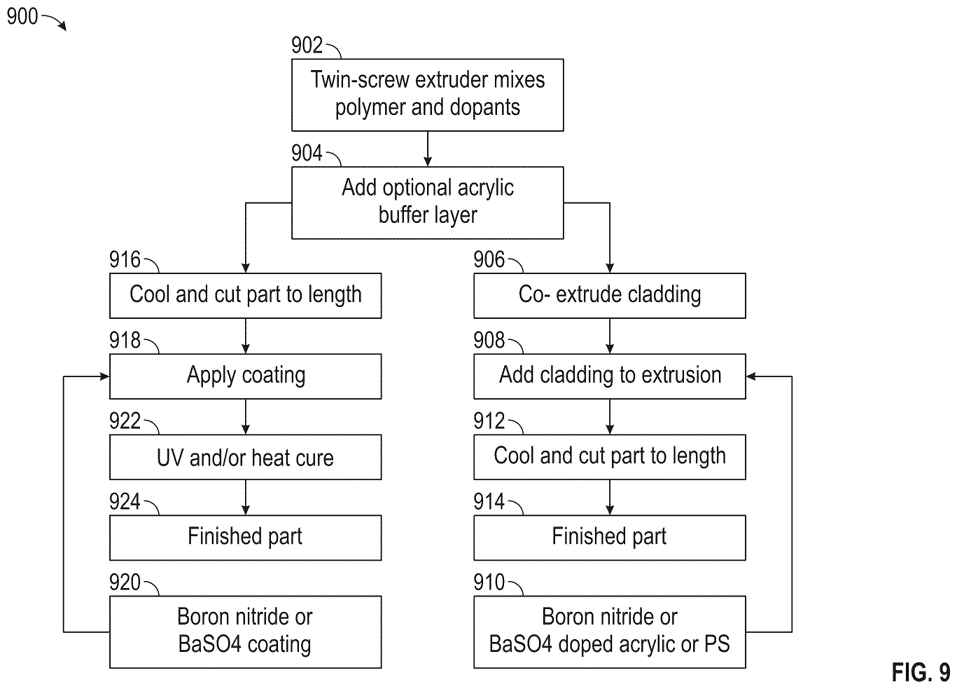

FIG. 9 illustrates aspects of a method 900 for manufacturing a scintillator in accordance with the disclosed embodiments. The method starts at step 902 where a polymer and dopants are mixed and melted. In certain embodiments, this is completed with a twin extruder. In other embodiments, other tools for mixing and melting the polymer and dopants is possible.

In certain embodiments, the polymer pellets can comprise polycarbonate resin pellets, polystyrene pellets, or other such materials. The primary dopant can be p-Terphenyl (pT) or 2,5-Diphenyloxazole (PPO) in a concentration between 1% and 5% by weight. In certain embodiments, a secondary wavelength-shifting dopant such as, but not limited to 1,4-Bis(2-methylstyryl)benzene (bis-MSB) or 1,4-bis-2-(5-Phenyloxazolyl)-benzene (POPOP) in a concentration between 0.01% and 0.1% can also be added. It should be appreciated that, in other embodiments, the primary dopant can be another materials.

Next at step 904 an acrylic buffer layer can optionally be added. This step comprises co-extruding the acrylic buffer layer with a second extruder onto the hot extrusion, as the part comes out of the die that is on the twin extruder. The part is cooled and cut to length. At this point the part is ready for further processing.

In one embodiment, at step 906, the process includes co-extruding the cladding onto hot extrusions using a third extruder. As illustrated at 908, a cladding can be added to the extrusion. This can comprise the addition of boron nitride or BaSO₄ doped acrylic, or PS as illustrated at 910.

The part can then be cooled and cut to length at step 912, at which point the finished part is completed at step 914.

Alternatively, after the acrylic buffer layer is added, at step 916, the part is cooled, cut to length, and prepared for the application of a coating. At step 918, the part is coated with an inline painting process. The coating can comprise boron nitride or BaSO⁴ as illustrated by 920.

At step 922, the part is cured. This can comprise a UV and/or heat treatment to cure the coating. At this point, the finished part is complete at step 924, and the method ends.

It should be understood that the methods disclosed herein are meant to be exemplary. In certain embodiments, steps shown or described in association with one method may be applied in another exemplary method without departing from the scope of the disclosure.

Based on the foregoing, it can be appreciated that a number of embodiments are disclosed herein. For example, in an embodiment a scintillator, comprises a polymer material, at least one dopant, and a cladding. In an embodiment, the polymer material comprises one of polycarbonate resin pellets mixed with the at least one dopant and polystyrene resin pellets mixed with the at least one dopant. In an embodiment, the cladding comprises a reflective cladding. In an embodiment, the cladding comprises boron nitride. In an embodiment, the cladding comprises barium sulfate.

In an embodiment a method for fabricating a scintillator comprises mixing a polycarbonate with at least one dopant and forming the scintillator from the mixed polycarbonate and at least one dopant. In an embodiment, mixing a polycarbonate with at least one dopant further comprises mechanically mixing the polycarbonate with the at least one dopant. In an embodiment, mechanically mixing the polycarbonate with the at least one dopant further comprises mixing the polycarbonate and the at least one dopant with a twin-screw extruder. In an embodiment, forming the scintillator further comprises casting the scintillator. In an embodiment, forming the scintillator further comprises injection molding the scintillator. In an embodiment, forming the scintillator further comprises extruding the scintillator. In an embodiment the method further comprises applying a cladding to the scintillator. In an embodiment, applying the cladding to the scintillator comprises painting the cladding on the scintillator. In an embodiment, the cladding comprises at least one of boron nitride and barium sulfate.

In an embodiment, a method for fabricating a scintillator comprises mixing a polymer with at least one dopant, forming the scintillator from the mixed polymer and at least one dopant, and applying a cladding to the scintillator. In an embodiment, the polymer comprises at least one of polycarbonate and polystyrene. In an embodiment, forming the scintillator further comprises casting the scintillator, injection molding the scintillator, and extruding the scintillator. In an embodiment, applying the cladding to the scintillator comprises painting the cladding on the scintillator. In an embodiment, the cladding comprises at least one of boron nitride and barium sulfate. In an embodiment, applying the cladding to the scintillator further comprises mixing the cladding with the polymer and at least one dopant.

It will be appreciated that variations of the above-disclosed and other features and functions, or alternatives thereof, may be desirably combined into many other different systems or applications. Also, various presently unforeseen or unanticipated alternatives, modifications, variations, or improvements therein may be subsequently made by those skilled in the art which are also intended to be encompassed by the following claims.

What is claimed is:

1. A scintillator, comprising:
a polymer material;
at least one dopant; and
a cladding.

2. The scintillator of claim 1 wherein the polymer material comprises one of:
polycarbonate resin pellets mixed with the at least one dopant; and
polystyrene resin pellets mixed with the at least one dopant.

3. The scintillator of claim 1 wherein the cladding comprises:
a reflective cladding.

4. The scintillator of claim 1 wherein the cladding comprises:
Boron Nitride.

5. The scintillator of claim 1 wherein the cladding comprises:
Barium Sulfate.

6. A method for fabricating a scintillator comprising:
mixing a polycarbonate with at least one dopant; and
forming the scintillator from the mixed polycarbonate and at least one dopant.

7. The method for fabricating a scintillator of claim 6 wherein mixing a polycarbonate with at least one dopant further comprises:
mechanically mixing the polycarbonate with the at least one dopant.

8. The method for fabricating a scintillator of claim 7 wherein mechanically mixing the polycarbonate with the at least one dopant further comprises:
mixing the polycarbonate and the at least one dopant with a twin-screw extruder.

9. The method for fabricating a scintillator of claim 6 wherein forming the scintillator further comprises:
casting the scintillator.

10. The method for fabricating a scintillator of claim 6 wherein forming the scintillator further comprises:
injection molding the scintillator.

11. The method for fabricating a scintillator of claim 6 wherein forming the scintillator further comprises:
extruding the scintillator.

12. The method of claim 6 further comprising:
applying a cladding to the scintillator.

13. The method of claim 12 wherein applying the cladding to the scintillator comprises:
painting the cladding on the scintillator.

14. The method of claim 12 wherein the cladding comprises at least one of:
Boron Nitride; and
Barium Sulfate.

15. A method for fabricating a scintillator comprising:
mixing a polymer with at least one dopant;
forming the scintillator from the mixed polymer and at least one dopant; and
applying a cladding to the scintillator.

16. The method for fabricating a scintillator of claim 15 wherein the polymer comprises at least one of:
polycarbonate; and
polystyrene.

17. The method for fabricating a scintillator of claim 15 wherein forming the scintillator further comprises:
casting the scintillator;
injection molding the scintillator; and
extruding the scintillator.

18. The method of claim 15 wherein applying the cladding to the scintillator comprises:
painting the cladding on the scintillator.

19. The method of claim 18 wherein the cladding comprises at least one of:
Boron Nitride; and
Barium Sulfate.

20. The method of claim 15, wherein applying the cladding to the scintillator further comprises:
mixing the cladding with the polymer and at least one dopant.
